(19) United States
(12) Patent Application Publication
(10) Pub. No.: US 2008/0061611 A1
(43) Pub. Date: Mar. 13, 2008

(54) Vehicle Seat With Cover Plate

(75) Inventors: Marcus Thies, Gevelsberg (DE); Andreas Irgang, Leichlingen (DE); Karsten Hilger, Lohmar-Honrath (DE)

Correspondence Address: FOLEY & LARDNER LLP, 777 EAST WISCONSIN AVENUE, MILWAUKEE, WI, 53202-5306, US

(73) Assignee: Johnson Controls GmbH

(21) Appl. No.: 11/587,667

(22) PCT Filed: Mar. 4, 2005
(86) PCT No.: PCT/EP05/02279

§ 371 Date: Oct. 26, 2006

(30) Foreign Application Priority Data
Apr. 28, 2004 (DE) 10 2004 020 913.8

(51) Int. Cl. B60N 2/00

(52) U.S. Cl. 297/220; 297/219.1

(57) ABSTRACT

A vehicle seat is provided. The vehicle seat comprises a seat structure, a padded body supported by the seat structure, a seat cover which at least partially covers the padded body and defines a recess for the passage of a functional unit, a cover plate at least partially covering the recess, and at least one strip-shaped reinforcing element connected to the seat cover along an edge of the recess. A projection coupled to the cover plate is engaged between the at least one strip-shaped reinforcing element and the seat cover for at least partially securing the cover plate to the vehicle seat.

### CROSS-REFERENCE TO RELATED PATENT APPLICATIONS

The present Application is a National Phase Application of PCT/EP2005/002279 entitled, “Vehicle Seat with Cover Plate” filed on Mar. 4, 2005 which published under PCT Article 21(2) on Nov. 17, 2005 as WO 2005/108159 A1 in the German language, which claims priority to German Patent Application DE 10 2004 020 913.8 filed Apr. 28, 2004, the entire disclosure of which, including the specification and drawings, is expressly incorporated herein by reference.

### BACKGROUND

The present invention relates generally to a vehicle seat with a seat structure, a padded body and a seat cover which at least partially covers the latter and has a recess for the passage of a functional unit, such as a handle or an airbag, and is provided in the region of this recess with a cover plate.

German Patent No. DE 199 33 447 A1 discloses a vehicle seat of a generic type. The vehicle seat disclosed includes a backrest having a supporting structure which is equipped with a padded body in a region that is likely to contact the back of a seat occupant. The padded body is equipped with a seat cover which has a recess for the passage of a functional unit in the form of a deploying side airbag. The recess is closed by a cover plate which is provided with a predetermined breaking point and is sewn to the seat cover.

For vehicle seats of this type, the cover plate is integrated into the seat cover during the manufacturing of the seat. This creates a problem for functional units which have to remain accessible during the installation of the seat or for later maintenance work.

Accordingly, there is a need for providing a simply designed vehicle seat of the generic type having a cover plate which can be attached and/or subsequently removed and can be attached in a visually attractive and functionally reliable manner.

### SUMMARY

One exemplary embodiment relates to a vehicle seat. The vehicle seat includes a seat cover defining a passage or recess. At least one edge of the recess is provided with a reinforcing element, having in one embodiment a strip-shaped design, which runs along this edge and the border of which (i.e., a portion of the strip-shaped reinforcing element opposite the edge), can be engaged from behind by the cover plate. During the manufacturing of the seat cover, only the strip-shaped reinforcing element is permanently connected to the seat cover while the cover plate is installed in a form-fitting manner with the border of the strip-shaped reinforcing element on the already upholstered vehicle seat. A subsequent removal of the cover plate is possible by manual undoing of the form-fitting connection.

Another exemplary embodiment relates to a vehicle seat including a seat cover defining a recess having at least two mutually opposite edges. The at least two mutually opposite edges of the recess are provided with reinforcing strips, with it being possible, if appropriate, for further fastening means for fixing the cover plate to be completely omitted.

According to an exemplary embodiment, the reinforcing strip includes a first portion (e.g., a first half, etc.) and a second portion (e.g., a second half, etc.). The fastening of the reinforcing strips to the seat cover advantageously takes place in the region of the first half of the reinforcing strip which faces the edge of the recess so that that part of the reinforcing strip (e.g., the second half, etc.) can be pivoted in relation to the seat cover and can be securely engaged behind by the cover plate.

According to another exemplary embodiment, the permanent connection between seat cover and reinforcing strip takes place, in particular, by sewing. According to such an exemplary embodiment, it is advantageous to use a reinforcing strip formed of a foamed plastic, in particular foamed polypropylene (PP). Such a material is reasonably priced, has sufficient rigidity in order to ensure the form-fitting connection between the seat cover and the cover plate, and can easily be sewn.

According to another exemplary embodiment, the cover plate has projections which can be inserted between the reinforcing strip and the seat cover to provide the form-fitting connection. According to one exemplary embodiment, the projections are provided on a surface of the cover plate which faces the seat cover (e.g., a bottom surface, etc.). According to another exemplary embodiment, the projections have a substantially triangular contour, in lateral view, with a plate-side base and a plate-remote vertex. According to one exemplary embodiment, the plate-remote vertex of the projection protrudes over or beyond the base in a lateral direction toward the recess.

According to another exemplary embodiment, in order to hold the cover plate in a fixed position, provision can furthermore be made to additionally anchor the cover plate to a metal structure of the vehicle seat.

According to another exemplary embodiment, the recess defined by the seat cover is provided on an upper edge of a backrest of the vehicle seat. The cover plate is configured to at least partially conceal this recess and is provided with an aperture or leadthrough for a handle to unlock the backrest and also a sleeve-like molded-on element for receiving a support member of a head restraint (e.g., a holding bar, etc.). According to such an embodiment, the molded-on element preferably has means for locking the height of the support member.

Another exemplary embodiment relates to a vehicle seat. The vehicle seat includes a seat structure, a padded body supported on the seat structure, a seat cover at least partially covering the padded body and defining a recess, a reinforcing element connected to the seat cover along an edge of the recess, and a cover plate at least partially covering the recess. The cover plate has a first surface facing away from the recess and a second surface facing toward the recess. The vehicle seat also includes a projection having first portion supported at the second surface of the cover plate and a second portion engaged between the reinforcing element and the seat cover to at least partially secure the cover plate to the vehicle seat.

Another exemplary embodiment relates to a method of at least partially concealing a recess provided in a seat cover of a vehicle seat. The method includes the steps of providing a cover plate having a first surface configured to face away from the recess and a second surface configured to face the recess, providing at least one projection at the second surface, providing a reinforcing element having first portion and a second portion, connecting the first portion of the reinforcing element to a portion of the seat cover defining the recess, and engaging the at least one projection between the seat cover and the second portion of the reinforcing element to at least partially secure the cover plate to the vehicle seat.

### BRIEF DESCRIPTION OF THE DRAWINGS

FIG. 1 is a top perspective view of a vehicle seat having a backrest according to a exemplary embodiment.

FIG. 2 is a sectional view of an upper edge of the backrest of FIG. 1 showing a seat cover, reinforcing element and projection according to an exemplary embodiment.

FIG. 3 is a partial detailed view of the backrest of FIG. 2.

### DETAILED DESCRIPTION

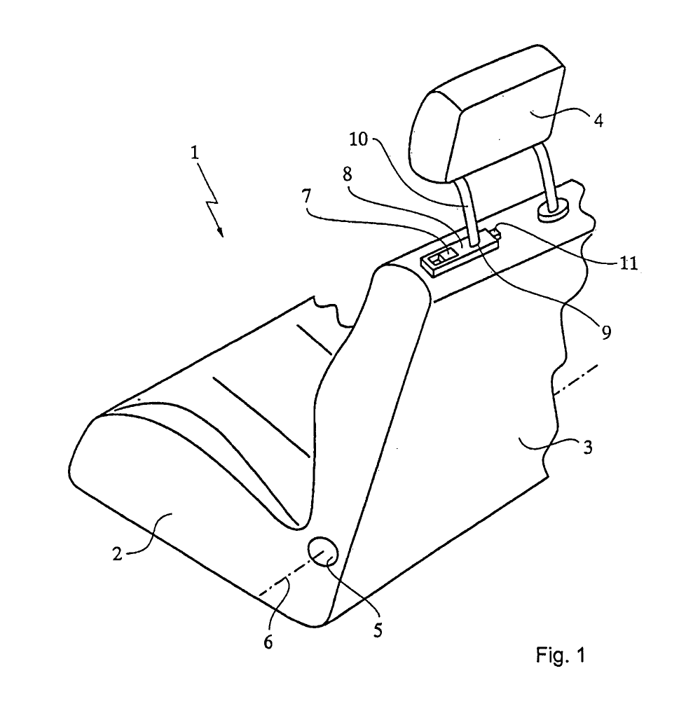

The vehicle seat 1 shown in FIG. 1 comprises a seat part 2 and a backrest 3 which is provided with a head restraint 4. The backrest 3 can be folded forward in relation to the seat part 2 through approximately 90° about an axis of rotation 6 in a lockable joint 5 in order to enlarge the loading volume of the trunk or to make the rear side of the backrest 3 useable as a table surface. The unlocking of the joint 5 takes place by actuation of a handle 7 which is embedded in a cover plate 8 in the upper edge of the backrest 3 and can be operated both from the interior of the vehicle and from the trunk.

The cover plate 8 has a receptacle 9, which is shown as being integrally formed on the cover plate 8, for a support member or holding bar 10 of the head restraint 4. Furthermore, in the region of the receptacle 9, means for locking the height of the holding bar 10 are shown as being integrated into the cover plate 8. This means for locking can be temporarily released by pressing a pushbutton 11 for the purpose of adjusting the height of the head restraint 4.

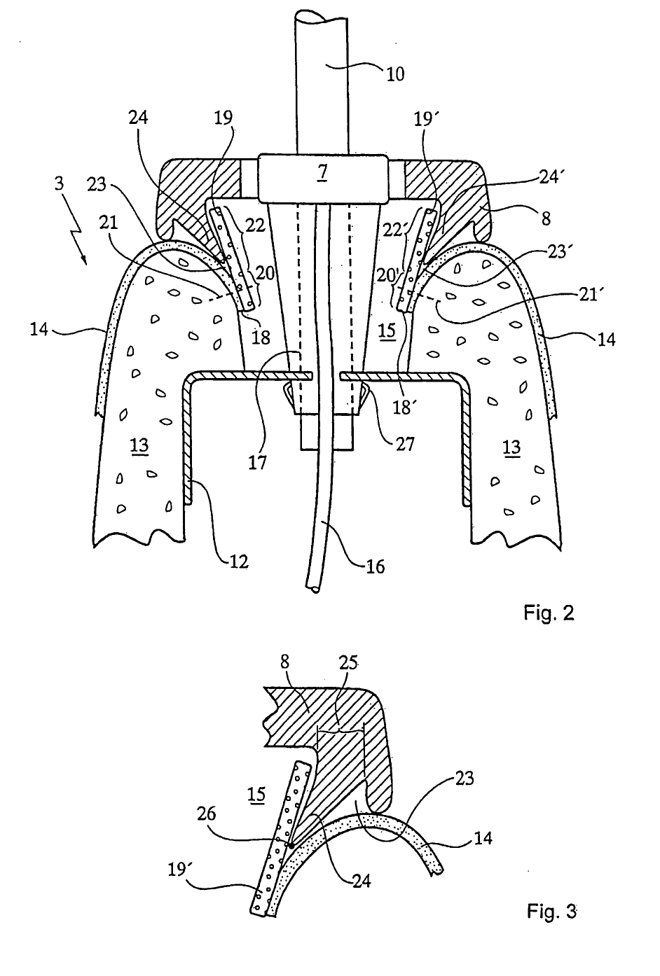

Referring to FIG. 2, a longitudinal section of the backrest 3 illustrates the construction of the cover plate 8 and of the upper edge of the backrest 3 in detail.

The backrest 3 comprises a seat structure 12 (e.g., a metallic seat structure, etc.) which is provided with a padded body 13. The padded body 13 is shown as being covered with a seat cover 14. Padded body 13 and seat cover 14 define, in the region of the handle 7, a recess 15 through which a Bowden cable 16 operatively connecting the handle 7 to the joint 5 and a sleeve-shaped molded-on element 17 of the cover plate 8 closing the recess 15 from the outside are guided.

According to the embodiment illustrated, the recess 15 includes opposite edges 18, 18′ which run along the upper region of the backrest 3. The seat cover 14 is provided with reinforcing strips 19, 19′ at these opposite edges 18, 18′ of the recess 15. The reinforcing strips 19, 19′ include first portions, shown as halves 20, 20′, and second portions, shown as halves 22, 22′. The reinforcing strips 19, 19′ are connected at their halves 20, 20′ facing the edges 18, 18′ to the seat cover 14 via seams 21, 21′. Those halves 22, 22′ of the stiff reinforcing strips 19, 19′ which face away from the edges 18, 18′, together with the associated curved regions of the seat cover 14, form clearances 23, 23′ which taper in a wedge-shaped manner and in which projections 24, 24′ integrally formed on the cover plate 8 engage in a form-fitting manner.

Referring to the enlarged detailed view of FIG. 3, the projection 24′ (analogous to projection 24) is shown as having an essentially triangular contour with a plate-side base 25 and a plate-remote vertex 26 which extends beyond or protrudes over the base 25 in a lateral direction toward the recess 15. Forming the projection 24 in this manner creates a relatively secure but nevertheless manually easily releasable form-fitting connection between the cover plate 8 and the seat cover 14.

Furthermore, the cover plate 8 is shown as being anchored to the backrest 3 by means of its sleeve-shaped molded-on element 17, which has latching projections 27, directly in the seat structure 12. Such a latching device can also be designed in such a manner that, by pulling in the direction of the longitudinal axis of the sleeve-like molded-on element 17, a removal of the cover plate 8 is possible but it is fixed in position in a direction orthogonal thereto.

1. A vehicle seat comprising:
a seat structure;
a padded body supported by the seat structure;
a seat cover which at least partially covers the padded body and defines a passage for receiving a functional unit the passage defining an edge;
a cover plate having a projection and at least partially covering the passage; and
at least one reinforcing element connected to the seat cover along the edge of the passage,
wherein a projection coupled to the cover plate is engaged between the at least one reinforcing element and the seat cover for at least partially securing the cover plate to the vehicle seat.

2. The vehicle seat of claim 1, wherein the at least one reinforcing element is strip-shaped and comprises a first reinforcing element provided along a first edge defining the recess and a second reinforcing element along an opposite second edge defining the recess.

3. The vehicle seat of claim 2, wherein the strip-shaped reinforcing element includes a first portion and a second portion, the first portion being connected to the seat cover and the second portion being engaged by the projection.

4. The vehicle seat of claim 3, wherein the first portion of the strip-shaped reinforcing element is sewn to the seat cover.

5. The vehicle seat of claim 2, wherein the strip-shaped reinforcing element is composed of a foamed plastic.

6. The vehicle seat of claim 1, wherein the projection is integrally formed with a bottom surface of the cover plate.

7. The vehicle of claim 6, wherein the projection has a substantially triangular cross section with a base proximate the cover plate and a vertex distal from the cover plate.

8. The vehicle seat of claim 7, wherein the vertex extends beyond the base in a lateral direction toward the recess.

9. The vehicle seat of claim 1, wherein the cover plate is anchored to the seat structure of the vehicle seat.

10. The vehicle seat of claim 9, wherein the seat part, the padded body and the seat cover are in the form of a backrest having an upper portion above which a head restraint is to be provided, the cover plate is arranged on the upper portion and has a sleeve for receiving a support member for supporting the head restraint.

11. The vehicle seat of claim 10, wherein the sleeve is configured to adjustably lock the height of the support member.

12. A vehicle seat comprising:
a seat structure;
a pad supported on the seat structure;
a seat cover at least partially covering the pad and defining a recess;
a reinforcing element connected to the seat cover along an edge of the recess;
a cover plate at least partially covering the recess, the cover plate having a first surface facing away from the recess and a second surface facing toward the recess; and
a projection having first portion supported at the second surface of the cover plate and a second portion engaged between the reinforcing element and the seat cover to at least partially secure the cover plate to the vehicle seat.

13. The vehicle seat of claim 12, wherein the reinforcing element comprises a first reinforcing element provided along a first edge defining the recess and a second reinforcing element along an opposite second edge defining the recess.

14. The vehicle seat of claim 12, wherein the reinforcing element is in the form of a strip having a first portion connected to the seat cover and a second portion engaged by the second portion of the projection.

15. The vehicle seat of claim 12, wherein the projection has a substantially triangularly shaped cross section including a base portion and a vertex, the base portion being supported at the second surface of the cover plate and the vertex extending beyond the base portion toward the recess.

16. The vehicle seat of claim 15, wherein the projection is integrally formed with the cover plate.

17. A method of at least partially concealing a recess provided in a seat cover of a vehicle seat, the method comprising:
providing a cover plate having a first surface configured to face away from the recess and a second surface configured to face the recess;
providing at least one projection at the second surface;
providing a reinforcing element having first portion and a second portion;
connecting the first portion of the reinforcing element to a portion of the seat cover defining the recess; and
engaging the at least one projection between the seat cover and the second portion of the reinforcing element to at least partially secure the cover plate to the vehicle seat.

18. The method of claim 17, further comprising forming the at least one projection with a cross section that is substantially triangularly-shaped, coupling a base portion of the projection to the second surface of the cover plate, and extending a vertex of the projection in a direction toward the recess and beyond the base portion.

19. The method of claim 18, further comprising integrally forming the at least one projection on the second surface of the cover plate.

20. The method of claim 17, further comprising sewing the first portion of the reinforcing element to an edge of the seat cover.
